(19) United States
(12) Patent Application Publication
(10) Pub. No.: US 2009/0259712 A1
(43) Pub. Date: Oct. 15, 2009

(54) DISTRIBUTED PROCESSING DEVICE, DISTRIBUTED PROCESSING METHOD, AND PROGRAM

(75) Inventor: Tomoyoshi SUGAWARA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/423,464

(22) Filed: Apr. 14, 2009

(30) Foreign Application Priority Data
Apr. 15, 2008 (JP) 2008-105327

(51) Int. Cl. G06F 15/16; G06F 15/173

(52) U.S. Cl. 709/201; 709/224; 709/226

(57) ABSTRACT

A distributed processing device provided in association with a first computer, the distributed processing device comprising: a communication delay measuring unit that measures, as first communication delay time, a communication delay time between first program operating on the first computer and second program operating on second computer connected with the first computer through a network; a communication delay acquiring unit that acquires, as a second communication delay time, a communication delay time between the second computer and third computer connected with the first and second computers through the network when the first and second programs communicate through the third computer; and a processing node changing unit that compares the first and second communication delay times and selects the third computer as a destination of the first program to be transferred when the second communication delay time is shorter than the first communication delay time.

### FIELD OF THE INVENTION

### Reference to Related Application

This application is based upon and claims the benefit of the priority of Japanese patent application No. 2008-105327, filed on Apr. 15, 2008, the disclosure of which is incorporated herein in its entirety by reference thereto.

This invention relates to a distributed processing device, distributed processing method, and program and more particularly to a distributed processing device, distributed processing method, and program that reduce a communication delay time in distributed processing among a plurality of computers.

### BACKGROUND

In a distributed system where processes are distributed between a client and a server, the distributed processes can be accelerated by transferring a process on the client or server to an appropriate node (a computer that makes up the distributed system). It also reduces power consumption in the distributed system as a whole.

As a method of choosing a processing node, mobile agents and process migration are well-known. A method of accelerating distributed processes and reducing power consumption by transferring a process based on mobile agents and process migration is as follows. The following procedure is repeated. A process is transferred to an arbitrary node and the node is selected if the speed or efficiency is improved while the process is transferred back to the original node if there is no improvement. However, there is a problem in this method that penalty and cost accompany the process transfer. In the case of mobile agents and process migration, idle time of a process, CPU time and communication time in the process transfer are not necessarily short. Therefore, it is necessary to select an appropriate node before a process is transferred.

As an example related to this problem, Patent Document 1 describes a distributed processing system which drastically reduces communication traffic and increases processing capability by efficiently choosing a node to run a process.

The distributed processing system operates in the following manner. With reference to FIG. 15 in Patent Document 1, when a mobile agent with a predetermined search condition is generated and transmitted to an information processing apparatus 2 by an information processing apparatus 1, the mobile agent determines whether the information processing apparatus 2 satisfies the search condition and, if the search condition is not satisfied, the mobile agent moves to an information processing apparatus 3. When the mobile agent has determined that the information processing apparatus 3 satisfies the search condition, the mobile agent preserves computer resources on the information processing apparatus 3 and thereupon informs the information processing apparatus 1 of the discovery. Subsequently, the information processing apparatus 1 informs the information processing apparatus 3 that the information processing apparatus 1 intends to the information processing apparatus 3 for a distributed processing and transfers a job to the information processing apparatus 3, the information processing apparatus 3 whereupon executes the job.

### [Patent Document 1]

JP Patent Kokai Publication No. JP-P2006-048290A

### SUMMARY

The entire disclosure of Patent Document 1 is incorporated herein by reference thereto. The following analysis is given by the present invention.

In a distributed processing system described in the above Patent Document 1, a most appropriate node to run a process is searched by causing a mobile agent to move to various nodes in the distributed processing system and examine status of each node.

However, there may be a case where a mobile agent described in Patent Document 1 cannot be used to increase speed and efficiency of a process by minimizing a communication delay time (turn around time, TAT) in communicating with a partner node. In other words, there may be a case where a mobile agent described in Patent Document 1 cannot communicate with a target node.

This is because there may be a case in a distributed processing system where a mobile agent is not permitted to communicate with a communication partner node due to restriction on method of communication and participants, although a processing to be transferred can communicate with the communication partner node. As an example of a case manner or method of communication and participants are restricted, there is a communication which requires authentification. When authentification is done in a communicating program in a communication which requires authentification, only this communicating program has a right to communicate with a program on a partner node. Therefore, there may be a case where a mobile agent cannot transmit a test packet to measure a communication delay time to the partner node even when the mobile agent can detect or identify the partner node.

Therefore, it is an object of the invention to provide a distributed processing device, distributed processing method, and program that can determine a node that reduces a communication delay time between processes without transferring a process between nodes in a distributed processing system.

According to a first aspect of the present invention, there is provided a distributed processing device provided in association with a first computer. The distributed processing device comprises: a communication delay measuring unit that measures, as a first communication delay time, a communication delay time between a first program operating on the first computer and a second program operating on a second computer connected with the first computer through a network; a communication delay acquiring unit that acquires, as a second communication delay time, a communication delay time between the second computer and a third computer connected with the first and second computers through the network when the first and second programs communicate through the third computer; and a processing node changing unit that compares the first and second communication delay times and selects the third computer as a destination of the first program to be transferred when the second communication delay time is shorter than the first communication delay time.

According to a second aspect of the present invention, there is provided a distributed processing method comprising: measuring by a first computer, as a first communication delay time, a communication delay time between a first program operating on the first computer and a second program operating on a second computer connected with the first computer through a network (termed as “delay measuring step” herein); acquiring by the first computer, as a second communication delay time, a communication delay time between the second computer and a third computer connected with the first and second computers through the network when the first and second programs communicate through the third computer (termed as “delay acquiring step”); and comparing by the first computer the first and second communication delay times and selecting by the first computer the third computer as a destination of the first program to be transferred when the second communication delay time is shorter than the first communication delay time, (termed as “comparing and selecting step”).

According to a third aspect of the present invention, there is provided a program that causes a first computer to execute: measuring, as a first communication delay time, a communication delay time between a first program operating on the first computer and a second program operating on a second computer connected with the first computer through a network; acquiring, as a second communication delay time, a communication delay time between the second computer and a third computer connected with the first and second computers through the network when the first and second programs communicate through the third computer; and comparing the first and second communication delay times and selecting the third computer as a destination of the first program to be transferred when the second communication delay time is shorter than the first communication delay time.

The meritorious effects of the present invention are summarized as follows.

According to the present invention, a node is determined such that a communication delay time between processes is reduced without transferring a process between nodes in a distributed processing system. This is because a node can be found so as to reduce the communication delay time without transferring a program by making a communication between a first program on a first computer and a second program on a second computer through a third computer while leaving the first program on the first computer. The present invention makes it possible to determine a node such that the communication delay time between processings is reduced even when programs that can communicate are restricted by authentification and so on.

### BRIEF DESCRIPTION OF THE DRAWINGS

FIG. 1 is a block diagram showing a structure of a first exemplary mode of the present invention.

FIG. 2 is a block diagram showing a structure of a second exemplary mode of the present invention.

FIG. 3 is a flowchart showing an operation of a first exemplary embodiment of the present invention.

FIG. 4 is a flowchart showing an operation of the first exemplary embodiment of the present invention.

FIG. 5 is a block diagram showing a structure of a second exemplary embodiment of the present invention.

FIG. 6 is a flowchart showing an operation of the second exemplary embodiment of the present invention.

FIG. 7 is a block diagram showing a structure of a third exemplary embodiment of the present invention.

### PREFERRED MODES

A first mode (mode 1) is aforementioned as the first aspect. In the first aspect, there are possible modes as follows.

The communication delay acquiring unit may acquire the second communication delay time for each of a plurality of the third computers. The processing node changing unit may compare the first and second communication delay times and selects a computer whose second communication delay time is the shortest among the third computers as a destination of the first program to be transferred when at least one of the second communication delay times is shorter than the first communication delay time. (mode 2)

A computer may comprise the distributed processing device. (mode 3)

A distributed processing system may comprise a plurality of the computers. (mode 4)

A further mode (mode 5) is aforementioned as the second aspect. In the second aspect, there are possible modes as follows.

The delay acquiring step may comprise acquiring by the first computer the second communication delay time for each of a plurality of the third computers. The comparing and selecting step may comprise comparing by the first computer the first and second communication delay times and selecting by the first computer a computer whose second communication delay time is the shortest among the third computers as a destination of the first program to be transferred when at least one of the second communication delay times is shorter than the first communication delay time. (mode 6)

A still further mode (mode 7) is aforementioned as the third aspect. In the third aspect, there are possible modes as follows.

The acquiring may comprise acquiring the second communication delay time for each of a plurality of the third computers. The comparing and selecting may comprise comparing the first and second communication delay times and selecting a computer whose second communication delay time is the shortest among the third computers as a destination of the first program to be transferred when at least one of the second communication delay times is shorter than the first communication delay time. (mode 8)

### [First Exemplary Mode]

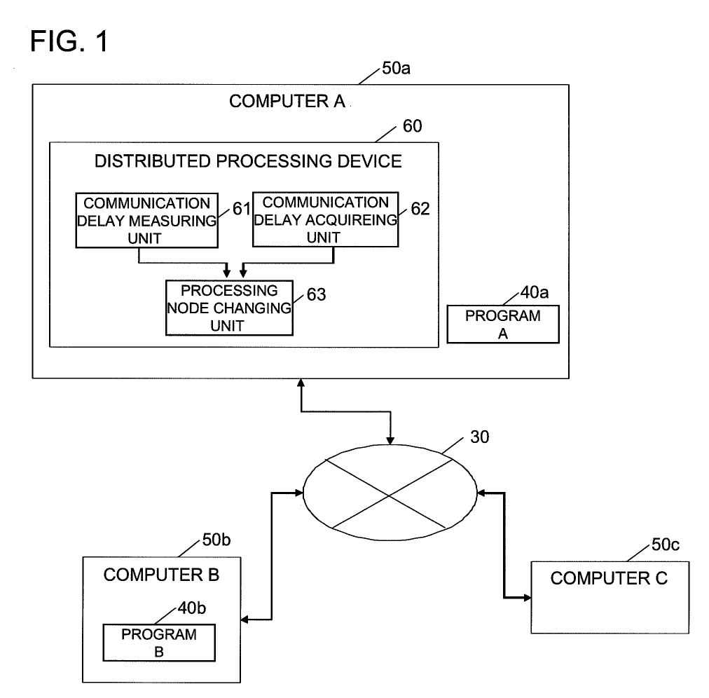

A distributed processing device according to a first exemplary mode of the present invention is described with reference to the drawings. FIG. 1 is a block diagram showing a structure of a first exemplary mode of the present invention. With reference to FIG. 1, a distributed processing device 60 provided in association with (e.g., on) a first computer 50a includes a communication delay measuring unit 61, a communication delay acquiring unit 62, and a processing node changing unit 63.

The communication delay measuring unit 61 measures, as a first communication delay time, a communication delay time between a first program 40a operating on the first computer 50a and a second program 40b operating on a second computer 50b connected with the first computer 40a through a network 30.

The communication delay acquiring unit 62 acquires, as a second communication delay time, a communication delay time between the second computer 50b and a third computer 50c connected with the first and second computers 50a, 50b through the network 30 when the first and second programs 40a, 40b communicate through the third computer 50c.

The processing node changing unit 63 compares the first and second communication delay times and selects the third computer 50c as a destination of the first program 40a to be transferred when the second communication delay time is shorter than the first communication delay time.

### [Second Exemplary Mode]

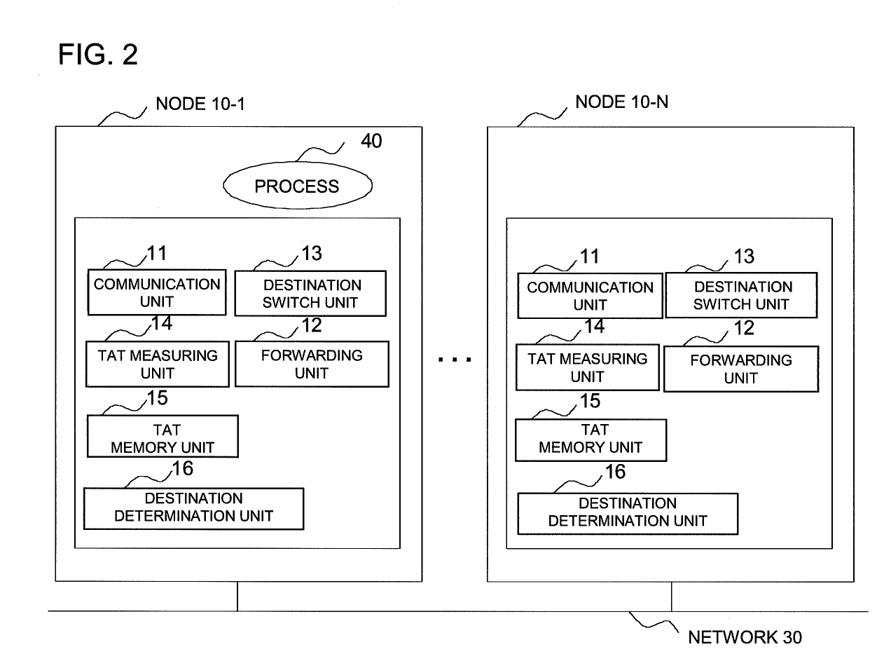

A distributed processing device according to a second exemplary mode of the present invention is described with reference to the drawings. FIG. 2 is a block diagram showing a structure of a distributed processing system according to the present exemplary mode. With reference to FIG. 2, the distributed processing system according to the present exemplary mode is a distributed system where at least two nodes (computers) 10-1 to 10-N are connected through the network 30 and programs each of which operates on a node communicate with each other. Each node 10-i (i=1 to N) includes a communication unit 11, a forwarding unit 12, a destination switch unit 13, a TAT measuring unit 14, a TAT memory unit 15, and a destination determination unit 16.

The communication unit 11 receives a data from a process 40 operating on a first node and transmits the data to a second node on which a communication partner program operates. The communication unit 11 receives a data forwarded from another node and transmits the data to a specified destination. The forwarding unit 12 receives and transmits the data to a third node which is other than the communication partner to transmit the data to the communication partner through the third node. The destination switch unit 13 switches between a communication unit 11 and a forwarding unit 12. The TAT measuring unit 14 measures a communication delay time in sending and receiving a data performed by the communication unit 11 and, if the data is forwarded by a forwarding unit 12 of another node, transmits the communication delay time to the forwarding unit 12 of the node. The TAT memory unit 15 stores a communication delay time measured by the TAT measuring unit 14. When the forwarding unit 12 receives a communication delay time from a third node, the destination determination unit 16 compares the communication delay time and a communication delay time stored in the TAT memory unit 15 and determines whether the process 40 is transferred to the third node based on the comparison.

By employing this structure and reducing a communication delay time between the process 40 and a process on the second node, the object of the present invention is achieved. Namely, according to the present invention, a node that reduces communication delay time, when a program is transferred to the node, can be selected without transferring a program (process) even when programs that can communicate are restricted by authentification and so on. This is because a first node transmits a message for a communication partner node through a third node and selects the third node as a destination of the process to be transferred when a communication delay time between the third node and the communication partner is shorter than a communication delay time between the first node and the communication partner node.

### First Exemplary Embodiment

A first exemplary embodiment, which relates to the second exemplary mode, is described in detail with reference to the drawings. With reference to FIG. 2, the first exemplary embodiment of the present invention includes nodes (computers) 10-1 to 10-N and a network 30 that connects the nodes 10-1 to 10-N.

Each of the nodes 10-1 to 10-N includes a process (program) 40, a communication unit 11, a forwarding unit 12, a destination switch unit 13, a TAT measuring unit 14, a TAT memory unit 15, and a destination determination unit 16. Each of these units operates in the following manner.

The process (program) 40 operating on a first node performs processings while communicating with a process operating on a second node. When the first node is a client that accesses a file and the second node is a file server, the process 40 may be, for example, a process (program) that sends and receives a file between the nodes.

The communication unit 11 sends and receives a data through the network 30. The communication unit 11 receives a data forwarded from another node and transmits the data to a specified destination. The destination specified in the communication unit 11 is an identifier of the second node.

The forwarding unit 12 forwards a data to be transmitted to the second node to a third node through the communication unit 11. The forwarding unit 12 selects the third node based on a predetermined method of node selection. The method of selecting a third node may be, for exemplary embodiment, a random selection. An identifier of the second node and an identifier of the first node that forwards a data are transmitted with the forwarded data. For exemplary embodiment, an IP address or a host name can be used as an identifier of a node.

The forwarding unit 12 receives (acquires), as a result of the forwarding, a communication delay time in forwarding a data from the third node that has actually transmitted the data and an identifier of the third node. The forwarding unit 12 transmits the received communication delay time and the node identifier to the destination determination unit 16.

The destination switch unit 13 switches-over between the communication unit 11 and the forwarding unit 12 based on a predetermined condition. The predetermined condition may be that the communication delay time exceeds a predetermined threshold.

The TAT measuring unit 14 measures a communication delay time between the process 40 and a process (not shown in the drawings) on another node. For example, a method of measuring a period between sending a TCP/IP packet and receiving acknowledgement (ACK) or a method of measuring a period between sending an HTTP GET request and receiving a response may be used as the method of measuring a communication delay time. When a data is forwarded from another node, the TAT measuring unit 14 transmits the measured communication delay time as well as an identifier of its node to a forwarding unit 12 that forwarded the data.

The TAT memory unit 15 stores a communication delay time that the TAT measuring unit 14 outputs. The stored contents include an identifier of a process and a communication delay time. A process name or a process number may be used as an identifier of a process. The communication delay time is a numerical data obtained in a measurement.

The destination determination unit 16 receives a communication delay time from the forwarding unit 12 and compares the received communication delay time and a communication delay time stored in the TAT memory unit 15 (namely a communication delay time when a data is transmitted from its own node) and determines whether the process 40 is transferred. The process may be transferred to the third node when the communication delay time between the third node and the second node is shorter. The destination determination unit 16 refers to an identifier of a third node that has actually transmitted a data in determining a destination node.

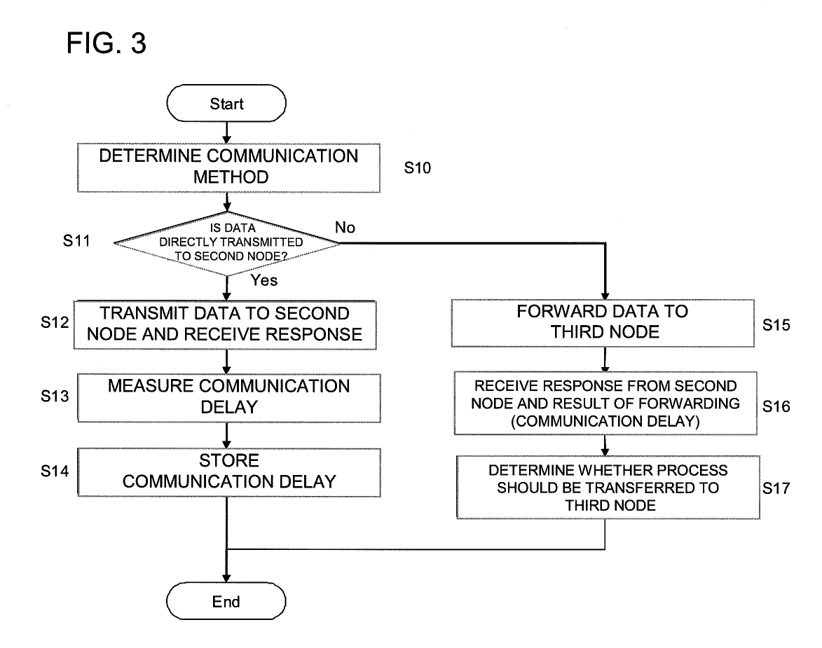

An operation of a first node that forwards a data in the present exemplary embodiment is illustrated with reference to a block diagram shown in FIG. 2 and a flowchart shown in FIG. 3. The destination switch unit 13 determines a communication method (Step S10). When it is determined that the communication is performed by the communication unit 11 and a data is transmitted directly to the second node (Step S11, Yes), the communication unit 11 transmits the data and receives a response (Step S12). The TAT measuring unit 14 measures a communication delay time (Step S13). The TAT memory unit 15 stores the communication delay time (Step S14).

When it is determined that the communication is performed by the forwarding unit 12 and a data is not transmitted directly to the second node (Step S1, No), the forwarding unit 12 forwards the data to the third node (Step S15). The forwarding unit 12 receives, from the third node to which the data is forwarded, a response from the second node and a communication delay time as a result of the forwarding (Step S16). The destination determination unit 16 determines whether or not the process 40 is to be transferred based on the received communication delay time (Step S17).

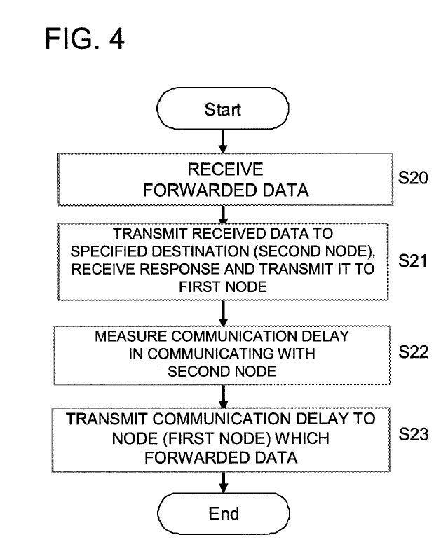

An operation of a third node in the present exemplary embodiment that receives a transferred data in the above step S15 is illustrated with reference to the block diagram shown in FIG. 2 and a flowchart shown in FIG. 4.

The communication unit 11 receives a forwarded data (Step S20). The communication unit 11 transmits the received data to a specified destination (second node), receives a response and transmits the response to the first node (Step S21). The TAT measuring unit 14 measures a communication delay time (Step S22). The TAT measuring unit 14 transmits the communication delay time to the first node that forwarded the data (Step S23).

The meritorious effect of the present exemplary embodiment is illustrated. In the present exemplary embodiment, by sending and receiving a data through another node (third node), a node is determined so as to reduce a communication delay time without transferring a communicating process. Therefore, a node that is appropriate as a destination of a process to be transferred can be selected at a lower cost than in the case where a process itself is transferred, even when processes that can communicate are restricted and mobile agents cannot be employed.

### Second Exemplary Embodiment

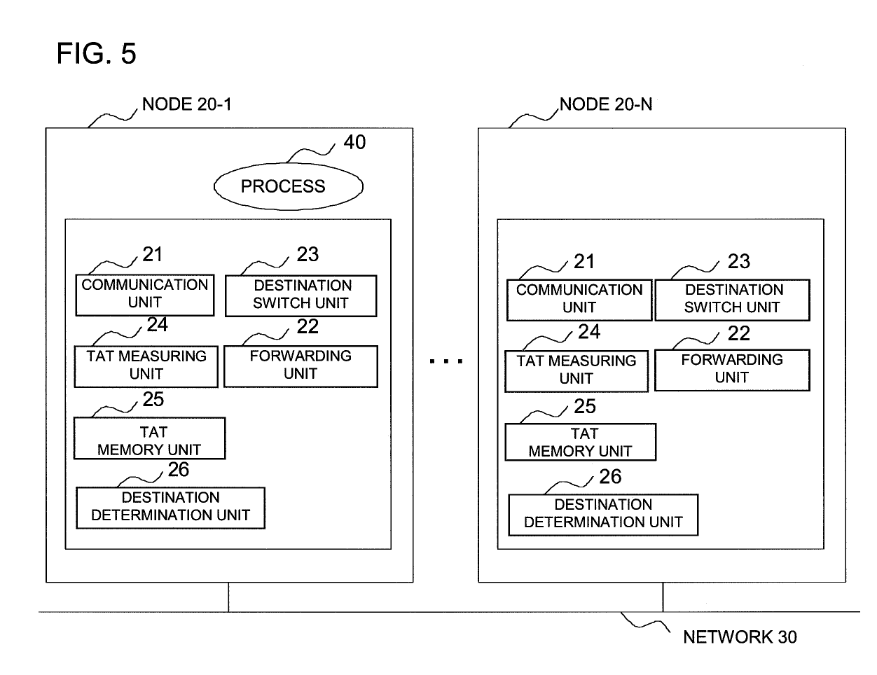

A distributed processing system according to a second exemplary embodiment of the present invention is described in detail with reference to the drawings. A destination determination unit 16 in the first exemplary embodiment determines whether the process 40 is transferred based on a single communication delay time received from a forwarding unit 12 and a communication delay time stored in a TAT memory unit 15. A destination determination unit in the present exemplary embodiment determines a destination after it receives a plurality of communication delay times each from a forwarding unit 12. FIG. 5 is a block diagram showing a structure of the second exemplary embodiment of the present invention.

With reference to the FIG. 5, the distributed processing system according to the second exemplary embodiment of the present invention includes nodes (computers) 20-1 to 20-N that operate under the control of a program and a network 30 that connects these nodes 20-1 to 20-N each other.

Each of the nodes 20-1 to 20-N includes a process 40, a communication unit 21, a forwarding unit 22, a destination switch unit 23, a TAT measuring unit 24, a TAT memory unit 25, and a destination determination unit 26. Each of these units operates in the following manner. The process 40, the communication unit 21, the destination switch unit 23 and the TAT measuring unit 24 operate in a similar manner as the process 40, the communication unit 11, the destination switch unit 13 and the TAT measuring unit 14 in the first exemplary embodiment.

The forwarding unit 22 forwards a data to be transmitted to the second node to a third node through the communication unit 21. The forwarding unit 22 selects a destination node (a third node) based on a predetermined method of node selection. The method of selection may be, for example, a random selection. An identifier of the second node and an identifier of the first node (transmission source) that forwards a data are transmitted together with the forwarded data. The forwarding unit 22 receives a communication delay time generated in transmitting the forwarded data to the second node by (from) the third node which is the transmission destination. The received communication delay time is transmitted to the TAT memory unit 25.

The TAT memory unit 25 stores a communication delay time which the TAT measuring unit 24 outputs. The TAT memory unit 25 stores a communication delay time outputted from the forwarding unit 22. The stored contents include an identifier of a process and an identifier of the third node that has actually performed transmission of the data and a communication delay time. A process name or a process number may be used as an identifier of a process. An IP address or a host name can be used as an identifier of a node. A numerical data obtained in a measurement is used as the communication delay time.

The destination determination unit 26 refers to the TAT memory unit 25, based on a predetermined condition, and starts a process of determining a destination of a process to be transferred. The predetermined condition may be when a predetermined count of communication delay times and identifiers of nodes are transmitted from the forwarding unit 22 to the TAT memory unit 25 or when a predetermined period has passed. The destination determination unit 26 refers to groups of an identifier of a process, an identifier of a node and a communication delay time stored in the TAT memory unit 25 and compares communication delay times related to the process 40. The destination determination unit 26 determines based on the comparison a destination of the process 40 to be transferred. A criterion for the determination may be that a node with a shortest communication delay time is selected as a destination. When a process is transferred, reference is made to an identifier of a node in a group, which is selected based on the above criterion from the groups of an identifier of a process, an identifier of a node and a communication delay time stored in the TAT memory unit 25.

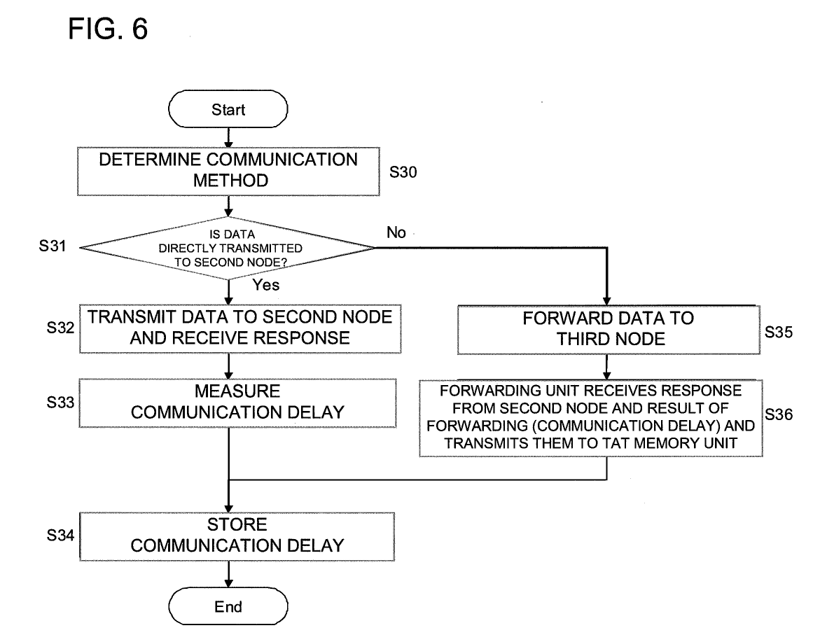

An operation of the present exemplary embodiment is illustrated with reference to a flowchart shown in FIG. 6. The destination switch unit 23 determines a communication method (Step S30). When it is determined that the communication is to be performed by the communication unit 21 (Step S31, Yes), the communication unit 21 transmits the data and receives a response (Step S32). The TAT measuring unit 24 measures a communication delay time (Step S33). The TAT memory unit 25 stores the communication delay time (Step S34) and the identifier of own node.

When it is determined that the communication is to be performed by the forwarding unit 22 (Step S31, No), the forwarding unit 22 forwards the data to the third node (Step S35). The forwarding unit 22 receives, from the third node (destination node) to which the data has been forwarded, a response from the second node and a communication delay time as a result of the forwarding and transmits them to the TAT memory unit 25 (Step S36). The TAT memory unit 25 stores the received pair (set) of the communication delay time and the identifier.

After steps S30 to S36 have been repeated several times, the destination determination unit 26 is invoked (called up). The destination determination unit 26 determines whether or not the process is to be transferred and, when the process is transferred, determines a node (destination node) to which the process is to be transferred.

The third node in the present exemplary embodiment to which the data is forward operates in a similar manner as the third node in the above first exemplary embodiment.

The meritorious effect of the present exemplary embodiment is illustrated. In the present exemplary embodiment, by comparing communication delay times for a plurality of nodes all together, number of transferring a process can be reduced compared with a number in the first exemplary embodiment where a process is transferred from one node to another whenever a shorter communication delay time is found.

### Third Exemplary Embodiment

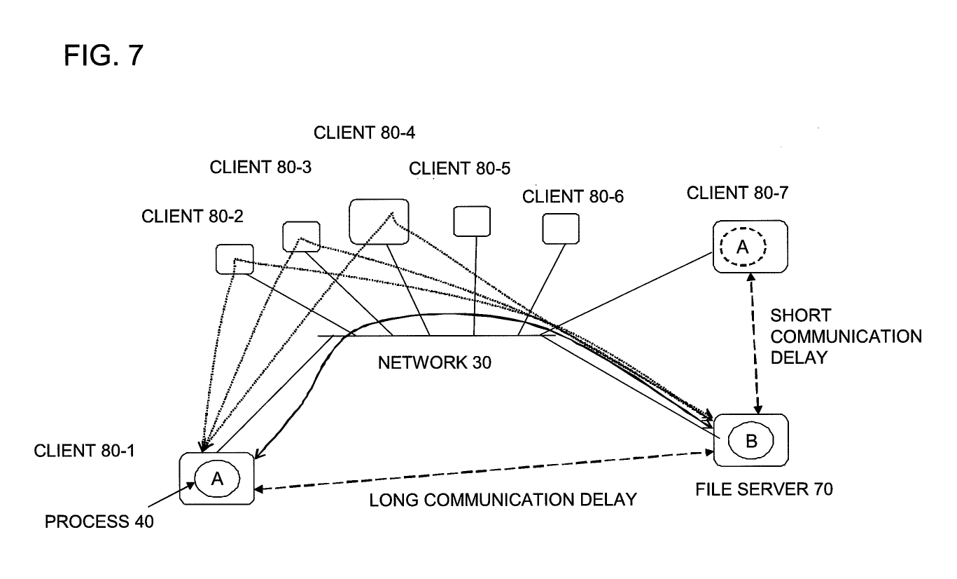

A third exemplary embodiment of the present invention is described with reference to the drawings. FIG. 7 is a block diagram showing a structure of the present exemplary embodiment. With reference to FIG. 7, a distributed processing system according to the present exemplary embodiment includes a file server 70, clients 80-1 to 80-7, and a network 30 that connects these elements each other. A count of the clients is arbitrary not less than 2.

The above first exemplary embodiment is applicable to the distributed processing system according to the present exemplary embodiment that provides a function of remote file access. In the present exemplary embodiment, each of the nodes operates as one of clients 80-1 to 80-7 and can access a file and remotely access a file on the file server 70 which is provided independently. It is assumed that each client 80-1 to 80-7 be a node according to the first exemplary embodiment according to the present invention.

Assume a case where a process 40 on the client 80-1 access a file on the file server 70 in an environment of each distributed processing system and a communication delay time between the client 80-1 and the file server 70 be long, a client which is appropriate for operating the process 40 is selected among the clients 80-1 to 80-7 according to the present invention. It is assumed that a communication delay time between the clients 80-1 to 80-7 and the file server 70 becomes shorter in the descending order 80-1, 80-2, . . . , 80-7.

First, a forwarding unit 12 communicates with the file server 70 through the client 80-2 while leaving the process 40 on the client 80-1. When a result is replied to the client 80-1, the client 80-1 compares communication delay times. As a result, the process 40 is determined to be transferred to the client 80-2. Similar processing is repeated and the process 40 is transferred to the client 80-3, 80-4, . . . , 80-7 successively. The process 40 is finally transferred to the client 80-7 having a shortest delay.

On the other hand, in case where the above second exemplary embodiment is applied to a distributed processing system of the present exemplary embodiment, the system operates in the following manner. Next, it is assumed that the maximum number of nodes compared at a time by the destination determination unit 26 is four. A communication through the client 80-2 is performed while leaving the process 40 operating on the client 80-1. Next, each of communications through each of the client 80-3 and the client 80-4 are performed. As a result of these communications, measured communication delay times are transmitted to the client 80-1 and stored. Four communication delay times which include the communication delay time for the client 80-1 are compared. As a result, the client 80-4 is determined as a destination. Next, a similar processing of determining a destination is performed on the next following four clients 80-4 to 80-7, likewise in the case of the first four nodes 80-1 to 80-4. Finally, the process 40 is transferred to the client 80-7.

As noted above, time for processing a file access is reduced by applying the present invention to a distributed processing system which provides a remote file access.

The present invention is applicable to an operation management system to speed up processing in a client-server type distributed system. The present invention is also applicable to an operation management system to reduce power consumption in a client-server type distributed system.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A distributed processing device provided in association with a first computer, the distributed processing device comprising:
a communication delay measuring unit that is adapted to measure, as a first communication delay time, a communication delay time between a first program operating on the first computer and a second program operating on a second computer connected with the first computer through a network;
a communication delay acquiring unit that is adapted to acquire, as a second communication delay time, a communication delay time between the second computer and a third computer connected with the first and second computers through said network when the first and second programs communicate through the third computer; and
a processing node changing unit that is adapted to compare the first and second communication delay times and to select the third computer as a destination of the first program to be transferred when the second communication delay time is shorter than the first communication delay time.

2. The distributed processing device of claim 1, wherein
the communication delay acquiring unit acquires the second communication delay time for each of a plurality of the third computers; and
the processing node changing unit is adapted to compare the first and second communication delay times and to select a computer whose second communication delay time is the shortest among the third computers as a destination of the first program to be transferred when at least one of the second communication delay times is shorter than the first communication delay time.

3. A computer, comprising the distributed processing device of claim 1.

4. A distributed processing system, comprising a plurality of the computers of claim 3.

5. A distributed processing method, comprising:
measuring by a first computer, as a first communication delay time, a communication delay time between a first program operating on the first computer and a second program operating on a second computer connected with the first computer through a network;
acquiring by the first computer, as a second communication delay time, a communication delay time between the second computer and a third computer connected with the first and second computers through the network when the first and second programs communicate through the third computer, termed as “acquiring step”; and
comparing, by the first computer, the first and second communication delay times and selecting, by the first computer, the third computer as a destination of the first program to be transferred when the second communication delay time is shorter than the first communication delay time, termed as “comparing and selecting step”.

6. The distributed processing method of claim 5, wherein
said acquiring step comprises acquiring by the first computer the second communication delay time for each of a plurality of the third computers; and
said comparing and selecting step comprises comparing by the first computer the first and second communication delay times and selecting by the first computer a computer whose second communication delay time is the shortest among the third computers as a destination of the first program to be transferred when at least one of the second communication delay times is shorter than the first communication delay time.

7. A program that causes a first computer to execute:
measuring, as a first communication delay time, a communication delay time between a first program operating on the first computer and a second program operating on a second computer connected with the first computer through a network;
acquiring, as a second communication delay time, a communication delay time between the second computer and a third computer connected with the first and second computers through the network when the first and second programs communicate through the third computer, termed as “acquiring step”; and
comparing the first and second communication delay times and selecting the third computer as a destination of the first program to be transferred when the second communication delay time is shorter than the first communication delay time, termed as “comparing and selecting step”.

8. The program of claim 7, wherein
said acquiring step comprises acquiring the second communication delay time for each of a plurality of the third computers; and
said comparing and selecting step comprises comparing the first and second communication delay times and selecting a computer whose second communication delay time is the shortest among the third computers as a destination of the first program to be transferred when at least one of the second communication delay times is shorter than the first communication delay time.
